(19) United States
(12) Patent Application Publication
(10) Pub. No.: US 2012/0217727 A1
(43) Pub. Date: Aug. 30, 2012

(54) Wheeled Collapsible Stand for a Power Driven Machine

(75) Inventor: Jackie Lee, Taichung (TW)

(73) Assignee: P & F Brother Industrial Corporation, Taichung (TW)

(21) Appl. No.: 13/035,847

(22) Filed: Feb. 25, 2011

(51) Int. Cl. B62B 1/04

(52) U.S. Cl. 280/652

(57) ABSTRACT

A wheeled collapsible stand for a power driven machine includes first and second frame units pivotally connected to each other and respectively pivotally connected to a tabletop bracing member that is adapted to support the machine thereon. The first frame unit includes front and rear frames pivotally coupled to each other such that the front frame is movable from an unfolded position to a folded position to displace the tabletop bracing member from a working position to a collapsed position. An extendible lifting unit is disposed to provide a lift to a front end of the tabletop bracing member to move toward the working position, and a buffer during movement of the tabletop bracing member to the collapsed position.

### BACKGROUND OF THE INVENTION

1. Field of the Invention

This invention relates to a wheeled collapsible stand for a power driven machine, more particularly to a wheeled collapsible stand that provides support for a portable power driven machine, such as a circular sawing machine, and that is collapsible conveniently.

2. Description of the Related Art

Referring to FIG. 1, a conventional stand 10 is shown to include a tabletop 11 for supporting a portable cutting machine 12, and a base frame 13 disposed under the tabletop 11. The tabletop 11 has a plurality of insert grooves 111 for respectively engaging upper ends of the base frame 13. The base frame 13 has first and second frames 131, 132 pivotally connected to each other. Two wheels 133 are mounted respectively on lower ends of the first frame 131 for rollably supporting the base frame 13 on the ground. The base frame 13 is unfolded for supporting the tabletop 11 at a working position, and is folded to permit the wheels 133 to roll on the ground for transportation. Such a rickety structure of the base frame 13, plus the simple connection between the insert grooves 111 and the upper ends of the base frame 13, renders the conventional stand 10 unfit for supporting the cutting machine 12 which is power driven and which thus requires a very steady working condition.

Referring to FIG. 2, another conventional stand 20 has a support 21 for supporting a tabletop (not shown), a first frame 22, a second frame 23, and a pair of linking shafts 24. The first frame 22 is pivotally connected to the support 21, and has opposite handgrip and foot ends 221, 222, and an intermediate portion pivotally connected to the second frame 23. The second frame 23 is coupled to the support 21 through the linking shafts 24 so as to permit folding and unfolding the first and second frames 22, 23. However, in order to successfully fold or unfold the frames 22, 23, the user has to keep holding up the support 21 during the folding or unfolding operation. It would be a hard task lifting up the support 21 for the folding or unfolding operation, particularly when there is a bulky machine mounted thereon.

### SUMMARY OF THE INVENTION

An object of the present invention is to provide a wheeled collapsible stand for a machine which can be folded and unfolded conveniently with less effort.

According to this invention, the wheeled collapsible stand includes a tabletop bracing member having front and rear ends, a first frame unit, a second frame unit, and an extendible lifting unit. The first frame unit has front and rear frames respectively having a front pivoted end and a rear wheel-carrying end, and linking and linked segments that are respectively opposite to the front pivoted end and the rear wheel-carrying end. The linking and linked segments are pivotally coupled to each other such that, when the linked segment is forced to move upward, the front frame is moved from an unfolded position to a folded position. The front pivoted end is pivotally connected to the front end of the tabletop bracing member such that, when the front frame is moved from the unfolded position to the folded position, the tabletop bracing member is displaced from a working position, where the front end is substantially level relative to the rear end, to a collapsed position, where the front end is disposed downwardly from the rear end. The second frame unit has a rear pivoted segment pivotally connected to the rear end of the tabletop bracing member, a front rest segment including first and second fulcrum regions which are selectively brought to rest on a ground when the tabletop bracing member is in the working and collapsed positions, respectively, and an intermediate portion pivotally connected to the linked segment of the rear frame such that the front rest segment is disposed forwardly of the rear wheel-carrying end. As a result of a lever action applied on the intermediate portion about the first fulcrum region, an upward force exerted on the intermediate portion is transmitted to move the linked segment upwardly so as to displace the tabletop bracing member to the collapsed position. The extendible lifting unit is disposed to provide a lift to the front end of the tabletop bracing member to move toward the working position, and a buffer during movement of the tabletop bracing member to the collapsed position.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a schematic view of a conventional wheeled collapsible stand;

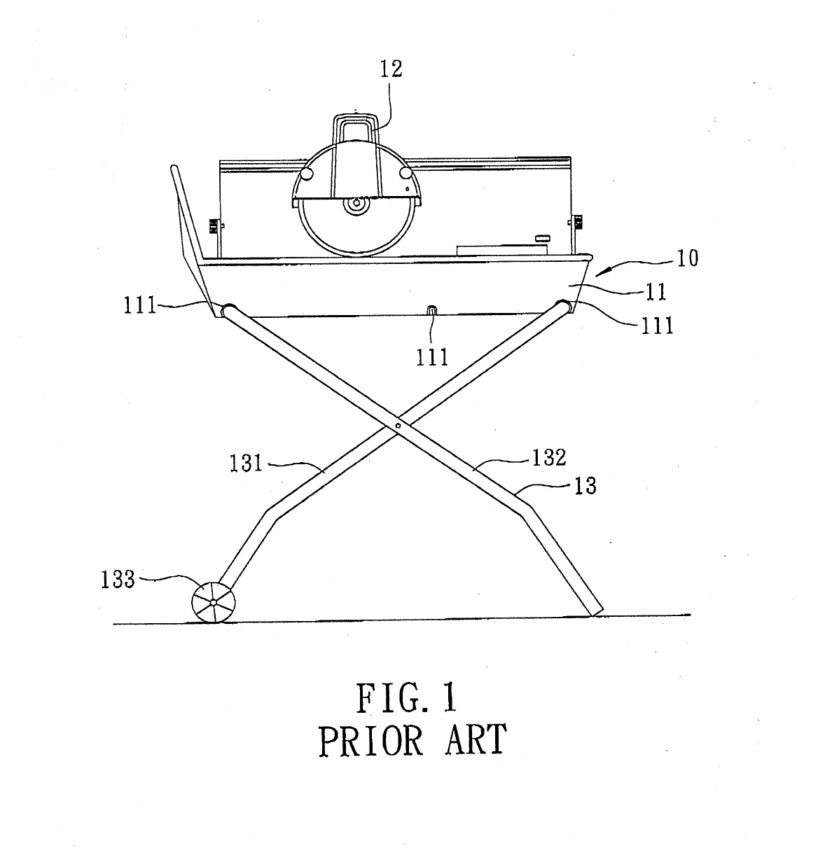

FIG. 2 is a schematic view of another conventional wheeled collapsible stand;

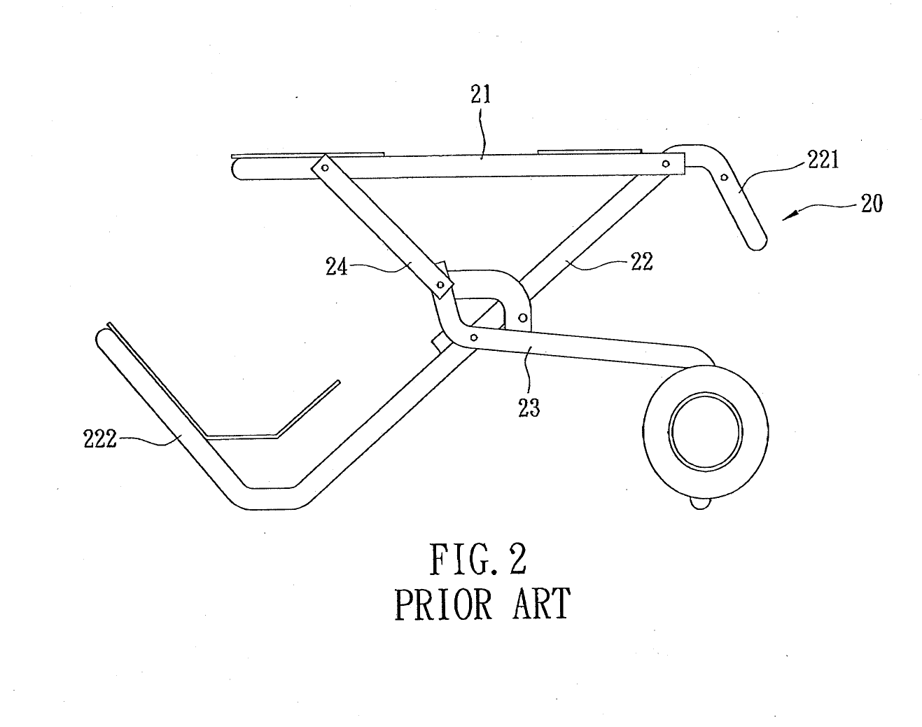

FIG. 3 is a perspective view of the preferred embodiment of a wheeled collapsible stand according to this invention when unfolded;

FIG. 4 is a top view of the preferred embodiment when unfolded;

FIG. 5 is a side view of the preferred embodiment when unfolded;

FIG. 6 is a perspective view of the preferred embodiment when folded;

FIG. 7 is another perspective view of the preferred embodiment when folded;

FIG. 8 is a top view of the preferred embodiment when folded;

FIG. 9 is a partly sectioned side view of the preferred embodiment when folded, taken along line IX-IX of FIG. 8;

FIG. 10 is a fragmentary sectional view showing a locking unit of the preferred embodiment;

FIG. 11 is a front view of the preferred embodiment; and

FIG. 12 is a partly sectioned view taken along line XII-XII of FIG. 11.

### DETAILED DESCRIPTION OF THE PREFERRED EMBODIMENT

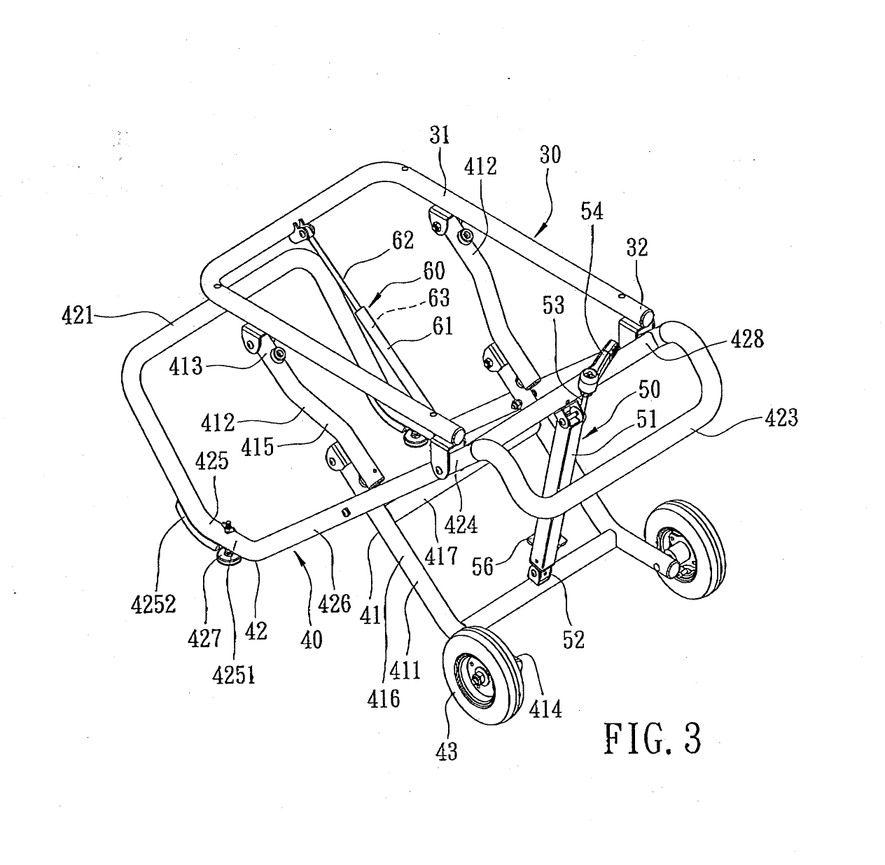

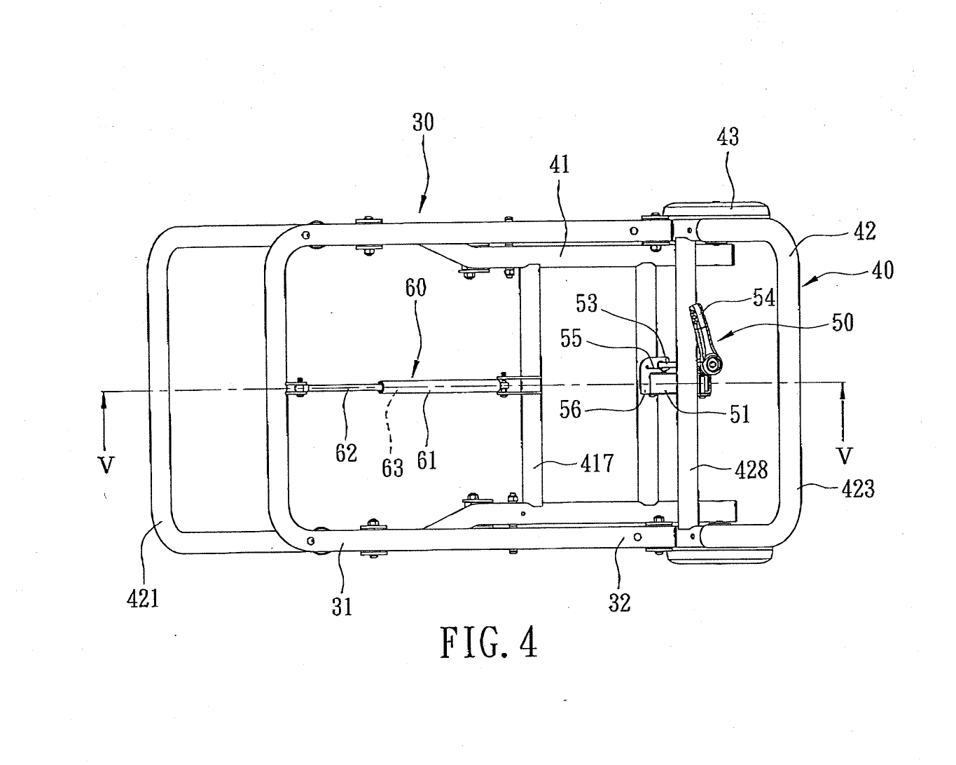

Referring to FIGS. 3 to 5, the preferred embodiment of a wheeled collapsible stand according to the present invention is shown to comprise a tabletop bracing member 30, a frame member 40, an extendible lifting unit 60, and a locking unit 50.

The tabletop bracing member 30 is rectangular in shape, is disposed for supporting a power driven machine (not shown), and has front and rear ends 31, 32.

The frame member 40 includes first and second frame units 41, 42.

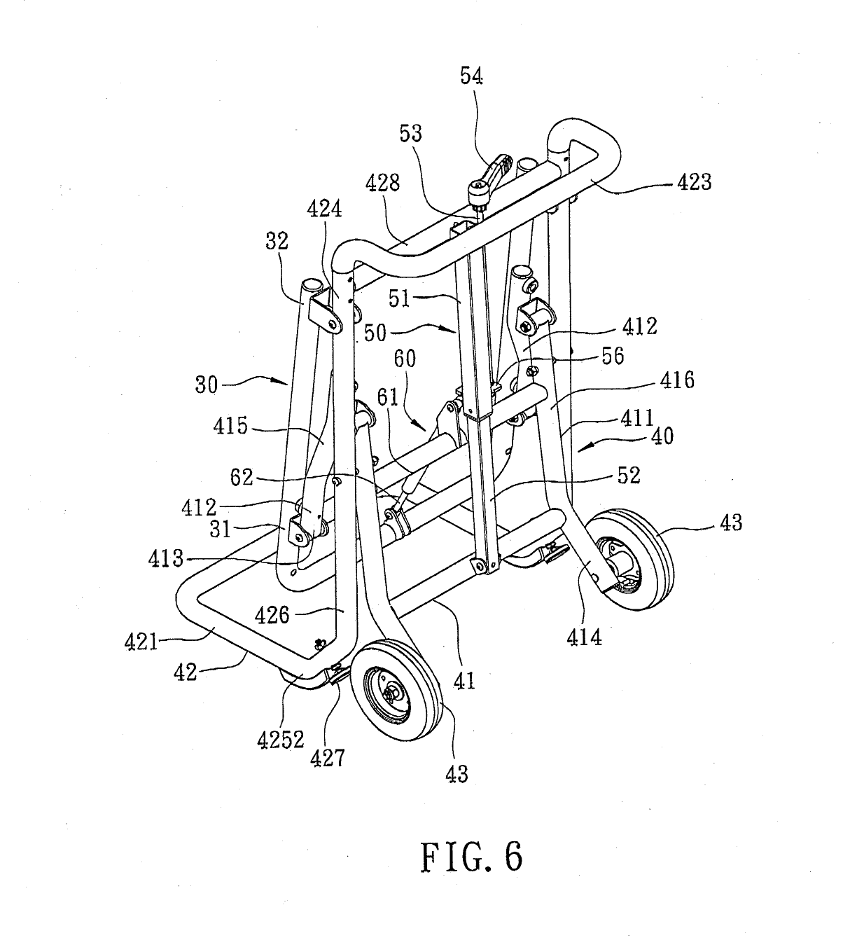

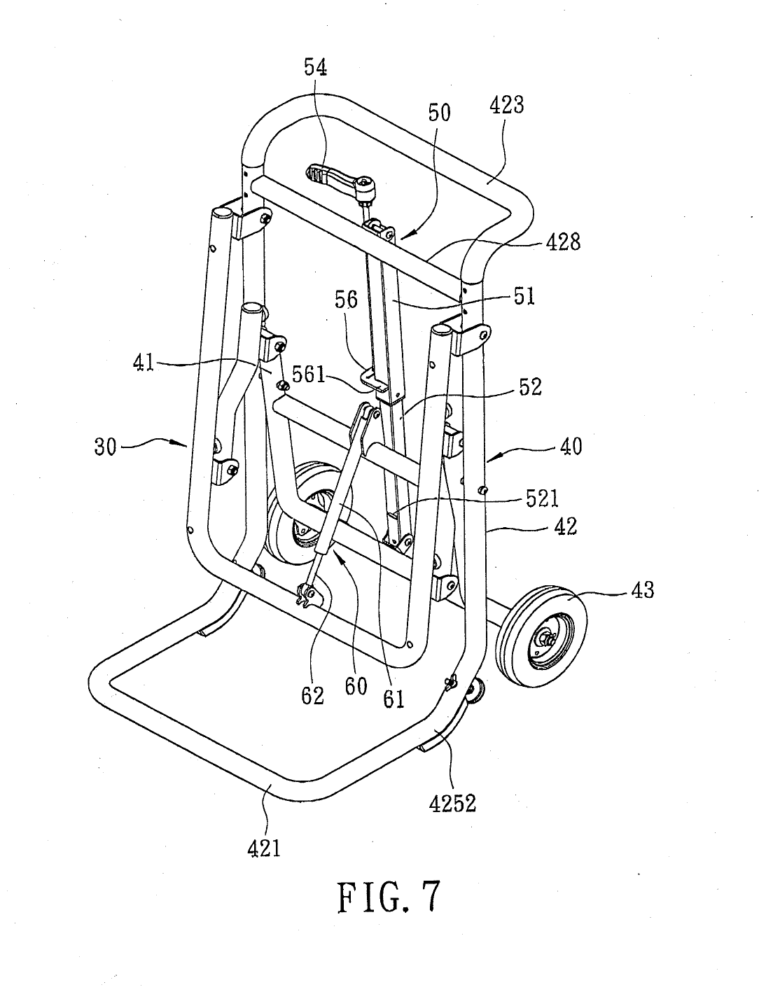

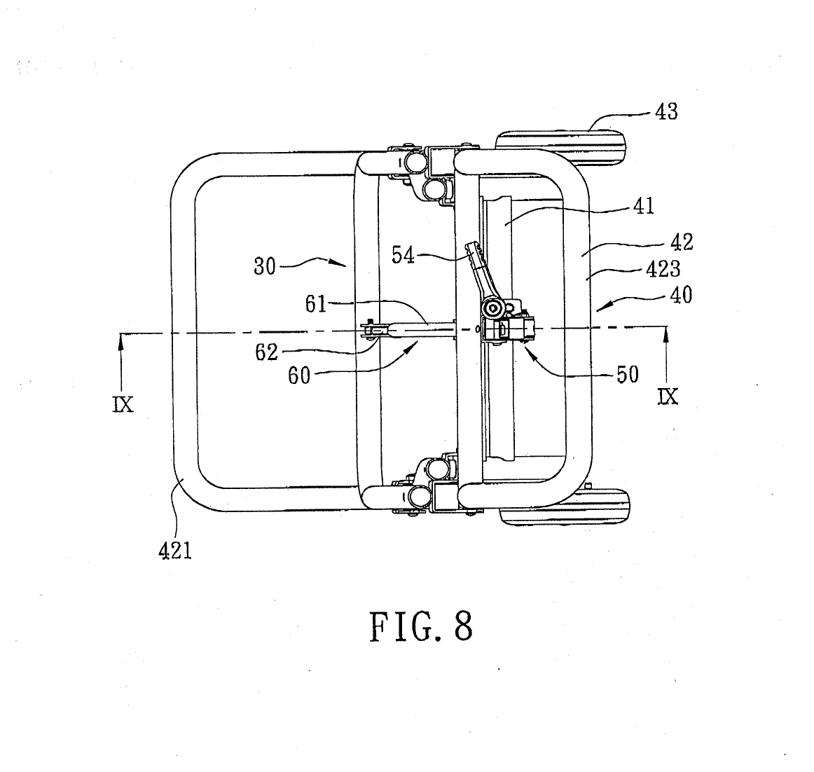

The first frame unit 41 has front and rear frames 412, 411 which respectively have a front pivoted end 413 and a rear wheel-carrying end 414, and which respectively have linking and linked segments 415, 416 that are respectively opposite to the front pivoted end 413 and the rear wheel-carrying end 414. The linking and linked segments 415, 416 are pivotally coupled to each other about a linking axis. The front pivoted end 413 is pivotally connected to the front end 31 of the tabletop bracing member 30 about a front axis parallel to the linking axis. A wheel unit 43 is rotatably mounted on the rear wheel-carrying end 414 for transportation. Accordingly, when the linked segment 416 is forced to move upward, the front frame 412 is moved from an unfolded position, as shown in FIGS. 3 to 5, where the front pivoted end 413 is remote from the rear frame 411, to a folded position, as shown in FIGS. 6 to 9, where the front pivoted end 413 is closer to the rear frame 411. Meanwhile, the tabletop bracing member 30 is displaced from a working position, where the front end 31 is substantially level relative to the rear end 32, to a collapsed position, where the front end 31 is disposed downwardly from the rear end 32.

The second frame unit 42 has a rear pivoted segment 424 which is pivotally connected to the rear end 32 of the tabletop bracing member 30 about a rear axis parallel to the linking axis, a front rest segment 425 which is disposed opposite to the rear pivoted segment 424, and which includes first and second fulcrum regions 4251, 4252, an intermediate portion 426 which is disposed between the rear pivoted segment 424 and the front rest segment 425, and which is pivotally connected to the linked segment 416 of the rear frame 411 about a pivot axis parallel to the linking axis such that the front rest segment 425 is disposed forwardly of the rear wheel-carrying end 414 of the first frame unit 41, a lower power segment 421 which extends upwardly from and transverse to the front rest segment 425, and a handgrip segment 423 which extends rearwardly and downwardly from the rear pivoted segment 424 to serve as a handle. The second fulcrum region 4252 is disposed between the first fulcrum region 4251 and the lower power segment 421 and is bent relative to the first fulcrum region 4251. Thus, when the tabletop bracing member 30 is in the working and collapsed positions, a support stud 427 of the first fulcrum region 4251 and the second fulcrum region 4252 are selectively brought to rest on the ground, respectively.

The extendible lifting unit 60 includes a hydraulic cylinder 61 pivotally connected to a crosspiece 417 transversely connected to the linked segment 416, a piston 63 which is disposed in and sealingly slidable relative to the hydraulic cylinder 61, and a plunger 62 disposed to connect the piston 63 to a crosspiece transversely disposed to the front end 31 of the tabletop bracing member 30. Alternatively, the hydraulic cylinder 61 may be pivotally connected to the intermediate portion 426 of the second frame unit 42. Thus, the extendible lifting unit 60 can provide a lift to the front end 31 of the tabletop bracing member 30 to move toward the working position, and a buffer during movement of the tabletop bracing member 30 to the collapsed position.

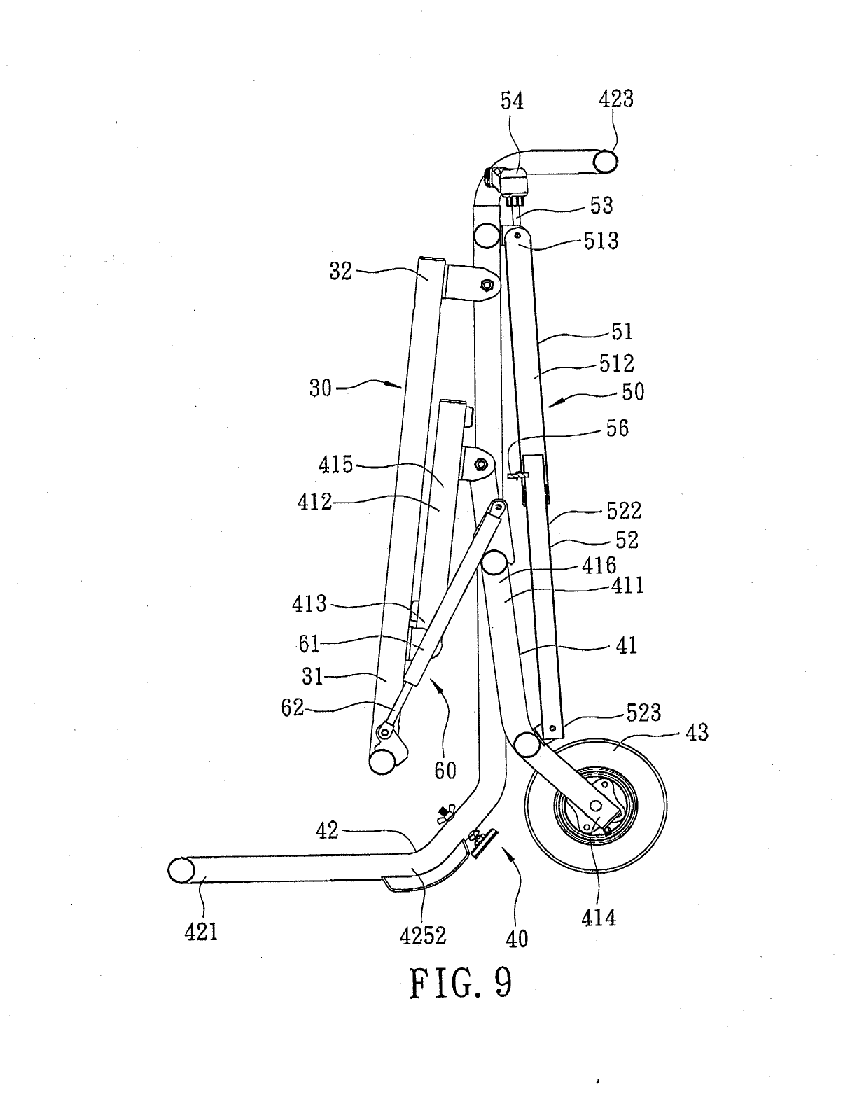

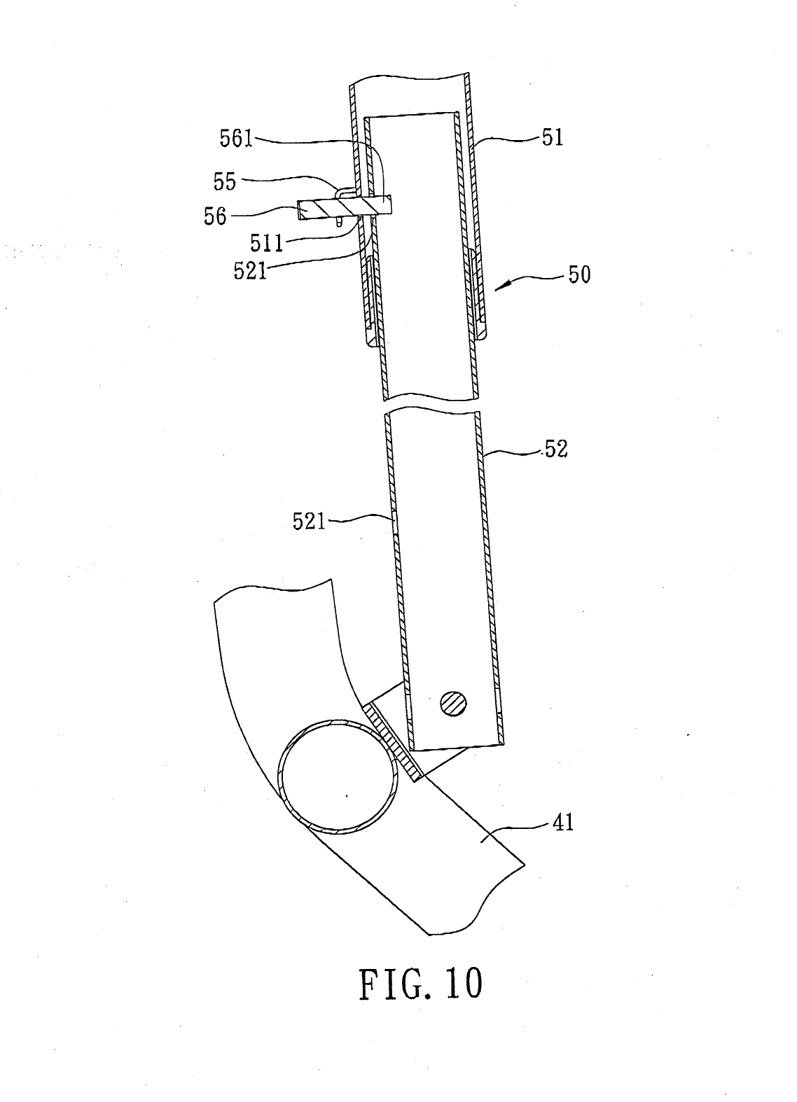

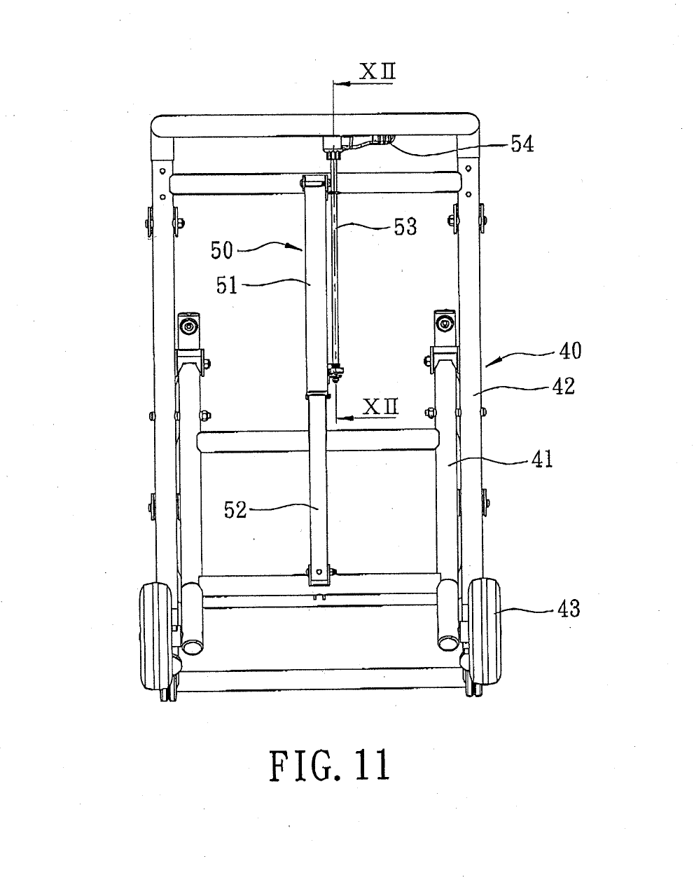

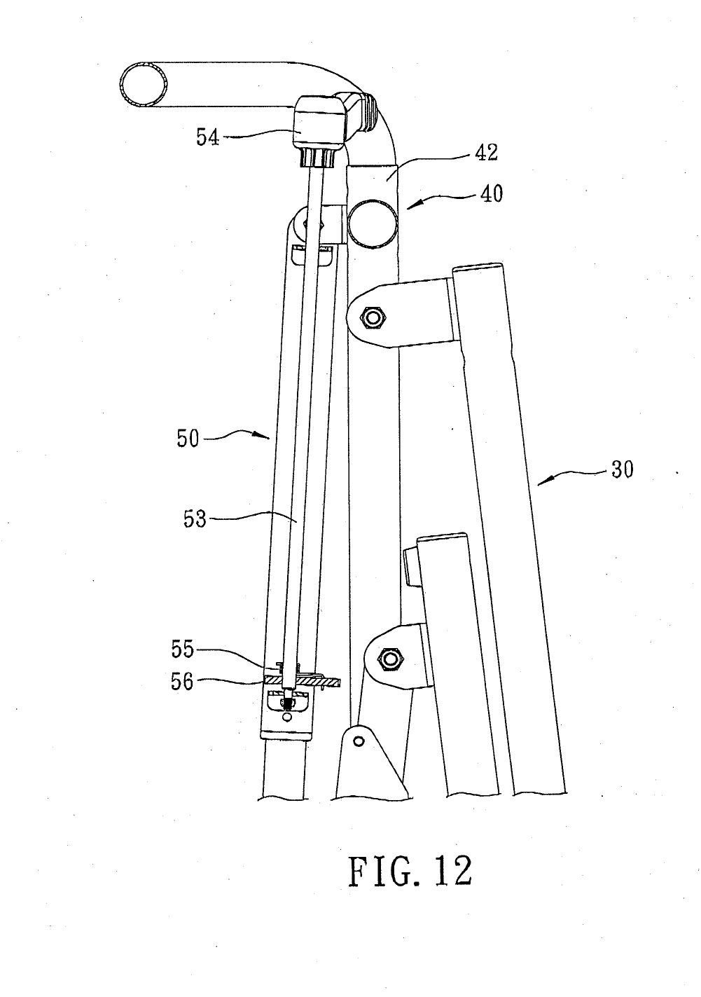

Referring to FIGS. 9 to 12, the locking unit 50 includes an outer tubular body 51, an inner tubular body 52, a latch 56, a biasing member 55, and an actuator rod 53. The outer tubular body 51 has an upper connected end 513 pivotally connected to the second frame unit 42 adjacent to the handgrip segment 423, and an outer tubular portion 512 extending downwardly from the upper connected end 513 and having a through hole 511. The inner tubular body 52 has a lower connected end 523 pivotally connected to the rear frame 411 adjacent to the rear wheel-carrying end 414, and an inner tubular portion 522 extending upwardly from the lower connected end 523 and telescopically fitted in the outer tubular portion 512. The inner tubular portion 512 has a plurality of latch holes 521 which are configured to be registered with the through hole 511 when the tabletop bracing member 30 is in the working position and the collapsed position, respectively. The latch 56 is of an L-shape, and has a latch end 561 movable through and relative to the through hole 511 between a latched position, where the latch end 561 extends to be engaged in one of the latch holes 521 when the tabletop bracing member 30 is in one of the working and collapsed positions so as to prevent the tabletop bracing member 30 from moving away from one of the working and collapsed positions, and an unlatched position, where the latch end 561 is disengaged from the latch holes 521, and an actuated end opposite to the latch end 561. The actuator rod 53 is disposed at an outside of the outer tubular body 51, and is swivellable relative to the outer tubular body 51. The actuator rod 53 has a lower rod end connected to the actuated end of the latch 56 so as to move the latch end 561 from the latched position to the unlatched position, and an upper rod end that extends upwardly of a crosspiece 428 transversely connected to the rear pivoted segment 424 and that has a twistable lever 54 for manual operation. The biasing member 55 is a torsion spring, and is disposed to bias the latch end 561 to the latched position.

When it is desired to fold the stand of the present invention, the twistable lever 54 is turned to displace the latch end 561 of the latch 56 to the unlatched position against the biasing action of the biasing member 55. The lower power segment 421 is actuated by a treading force to move downward about the first fulcrum region 4251 to apply a first lever action on the intermediate portion 426 so that an upward force exerted on the intermediate portion 426 is transmitted to move the linked segment 416 of the first frame unit 41 upward so as to move the front frame 412 to the folded position and to displace the tabletop bracing member 30 to the collapsed position, as shown in FIG. 9. During folding of the stand, by virtue of the mass of the tabletop bracing member 30 and by virtue of the buffer provided by the extendible lifting unit 60, the tabletop bracing member 30 can be displaced gradually and safely to the collapsed position.

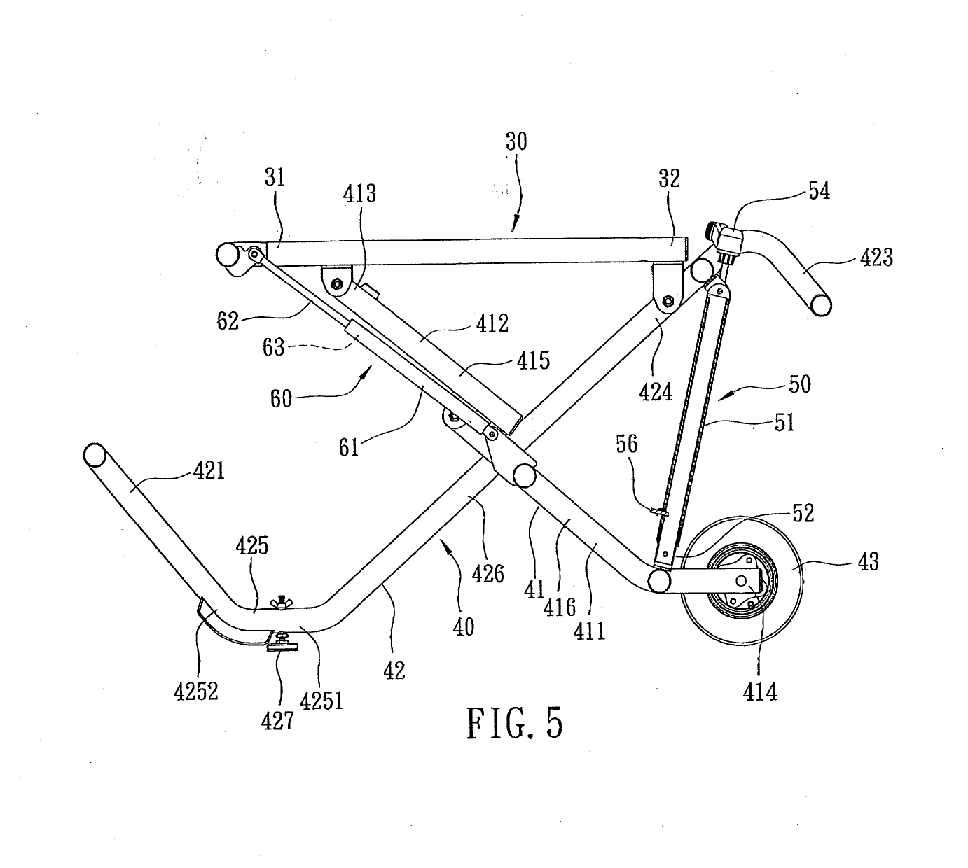

When it is desired to unfold the stand of the present invention, the latch 56 is turned to the unlatched position. Subsequently, a second lever action is applied on the handgrip segment 423 to lift the lower power segment 421 so as to permit the front frame 412 to displace to the unfolded position while permitting the front end 31 of the table top bracing member 30 to be urged by the biasing force of the extendible lifting unit 60, thereby facilitating displacement of the tabletop bracing member 30 to the working position, as shown in FIG. 5. During unfolding of the stand, by virtue of the lift provided by the extendible lifting unit 60, the tabletop bracing member 30 can be displaced effortlessly and conveniently.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A wheeled collapsible stand for a machine comprising:
a tabletop bracing member having front and rear ends;
a first frame unit having front and rear frames which respectively have a front pivoted end and a rear wheel-carrying end, and which respectively have linking and linked segments that are respectively opposite to said front pivoted end and said rear wheel-carrying end, said linking and linked segments being pivotally coupled to each other about a linking axis such that, when said linked segment is forced to move upward, said front frame is moved from an unfolded position, where said front pivoted end is remote from said rear frame, to a folded position, where said front pivoted end is closer to said rear frame, said front pivoted end being pivotally connected to said front end of said tabletop bracing member about a front axis parallel to the linking axis such that, when said front frame is moved from the unfolded position to the folded position, said tabletop bracing member is displaced from a working position, where said front end is substantially level relative to said rear end, to a collapsed position, where said front end is disposed downwardly from said rear end;
a second frame unit having
a rear pivoted segment which is pivotally connected to said rear end of said tabletop bracing member about a rear axis parallel to the linking axis,
a front rest segment disposed opposite to said rear pivoted segment, and including first and second fulcrum regions which are selectively brought to rest on a ground when said tabletop bracing member is in the working and collapsed positions, respectively, and
an intermediate portion which is disposed between said axis pivoted segment and said front rest segment, and which is pivotally connected to said linked segment of said rear frame about a pivot axis parallel to the linking axis such that said front rest segment is disposed forwardly of said rear wheel-carrying end, and such that as a result of a first lever action applied on said intermediate portion about said first fulcrum region, an upward force exerted on said intermediate portion is transmitted to move said linked segment upwardly so as to displace said tabletop bracing member to the collapsed position; and
an extendible lifting unit disposed to bias said front end of said tabletop bracing member to move toward the working position.

2. The wheeled collapsible stand according to claim 1, wherein said second frame unit further has a lower power segment extending upwardly from said front rest segment, and configured such that said lower power segment is actuated to move downward about said first fulcrum region to apply the first lever action on said intermediate portion.

3. The wheeled collapsible stand according to claim 1, wherein said extendible lifting unit includes a hydraulic cylinder pivotally connected to one of said linked segment and said intermediate portion, a piston which is disposed in and sealingly slidable relative to said hydraulic cylinder, and a plunger disposed to connect said piston to said front end of said tabletop bracing member.

4. The wheeled collapsible stand according to claim 1, wherein said second frame unit further has a handgrip segment which extends rearwardly from said rear pivoted segment to serve as a handle.

5. The wheeled collapsible stand according to claim 4, wherein said second fulcrum region is disposed between said first fulcrum region and said lower power segment to permit a second lever action applied on said handgrip segment to lift said lower power segment so as to facilitate the displacement of said tabletop bracing member to the working position.

6. The wheeled collapsible stand according to claim 4, further comprising a locking unit disposed to prevent said tabletop bracing member from moving away from one of the working and collapsed positions.

7. The wheeled collapsible stand according to claim 6, wherein said locking unit includes
an outer tubular body which has an upper connected end pivotally connected to said second frame unit adjacent to said handgrip segment, and an outer tubular portion extending downwardly from said upper connected end and having a through hole,
an inner tubular body which has a lower connected end pivotally connected to said rear frame adjacent to said rear wheel-carrying end, and an inner tubular portion extending upwardly from said lower connected end and telescopically fitted in said outer tubular portion, said inner tubular portion having two latch holes which are configured to be registered with said through hole when said tabletop bracing member is in the working position and the collapsed position, respectively,
a latch which has a latch end movable through and relative to said through hole between a latched position, where said latch end extends to be engaged in one of said latch holes when said tabletop bracing member is in one of the working and collapsed positions, and an unlatched position, where said latch end is disengaged from said latch holes, and
a biasing member disposed to bias said latch end to the latched position.

8. The wheeled collapsible stand according to claim 7, wherein said latch has an actuated end opposite to said latch end, said locking unit further including an actuator rod which is swivellable relative to said outer tubular body, and which has a lower rod end connected to said actuated end of said latch so as to move said latch end from the latched position to the unlatched position against biasing action of said biasing member, and an upper rod end that extends upwardly to near said handgrip segment for manual operation.
